(19) United States
(12) Patent Application Publication
(10) Pub. No.: US 2009/0263178 A1
(43) Pub. Date: Oct. 22, 2009

(54) POCKET FOR SHEET-RETAINING DEVICE AND RELATED MATERIAL AND METHOD

(76) Inventors: Sriram Venkatasanthanam, Chino Hills, CA (US); Ben Vanmarcke, Monrovia, CA (US); Evgueni Rozenbaoum, Arcadia, CA (US)

Correspondence Address: AVERY DENNISON CORPORATION;Patent Group, Law Department - 3 South, P.O. BOX 7090, PASADENA, CA, 91109-7090, US

(21) Appl. No.: 12/427,519

(22) Filed: Apr. 21, 2009

Related U.S. Application Data
(60) Provisional application No. 61/047,100, filed on Apr. 22, 2008.

(51) Int. Cl. B42F 13/00; B32B 27/08; B29D 31/00; B32B 37/00; B32B 37/04

(52) U.S. Cl. 402/73; 428/35.7; 428/36.8; 428/36.4; 428/35.2; 156/290; 156/73.5; 29/592

(57) ABSTRACT

An apparatus including a pocket that is at least partially defined by an elastomeric film, and a related method. The elastomeric film comprising a material that includes a styrene block copolymer, a polyolefin, a polyurethane, a polystyrene, an ethylene vinyl acetate copolymer, a processing oil, or mixtures thereof.

### CROSS-REFERENCE TO RELATED APPLICATION

Priority is claimed to U.S. Provisional Patent Application No. 61/047,100, filed on Apr. 22, 2008, entitled “Expandable Pockets for Sheet Retaining Devices Such As Loose Leaf Binders,” by Sriram Venkatasanthanam, Ben Vanmarcke, and Evgueni Rozenbaoum, which application is incorporated by reference in its entirety herein.

### FIELD OF THE INVENTION

The invention relates to the field of retaining devices. More specifically, the invention relates to pockets, and the materials from which the pockets are made, that are configured to retain objects.

### BACKGROUND

Typically, sheet-retaining devices, for example, binders, folders, report covers, dividers, and sheet protectors, include a sleeve or pocket in which one or more pieces of sheet material can be received. The primary purpose in providing such pockets is to enable the user to carry additional loose sheets, bound documents, or objects that are not designed to be stored in the primary holding mechanism of the device. The availability of multiple pockets extends the capacity to hold such items provided such a design fits within the manufacturing constraints of the device.

As described in U.S. Pat. No. 5,951,190 to Wilson, which is incorporated by reference herein in its entirety, a loose leaf binder can be provided with multiple horizontal and vertical pockets in both binder covers from a single sheet of die-cut material. However, the capacity of such pockets is still limited because they generally are manufactured from a thin sheet of material that is attached firmly to the cover, thus providing only a thin opening into which papers can be slid. These pockets generally begin to deform or appear overstuffed even with less than ten pages of paper in the pocket, and are quite insufficient when it comes to carrying bound documents, for example, notebooks. In case the user manages to force more than optimal number of sheets into such a pocket, the pocket will exhibit permanent deformation and lose its ability to hold pages securely. Such deformed pockets appear unsightly, and can cause the retaining device to lose its usefulness.

As shown in United States Patent Application Publication Number 2002/0050708 to Conklin, et al., which is incorporated by reference herein in its entirety, a binder can be provided with a built-in, loose paper storage system that allows for a reasonably large number of papers. However, such a system complicates the process of manufacturing, and adds a significant cost to the end user.

An additional drawback of conventional pockets is that there is a risk that pages held in the pocket can be dislodged if the device is turned upside down or sideways. United States Patent Application Publication Number 2006/0055167 to Pollman, et al., which is incorporated by reference herein in its entirety, shows a pocket design with the use of a secondary flap that is adapted to lock and retain the free corner of a sheet of material. This approach, however, constrains the process of insertion and removal of pages from the pocket, and does not enable secure storage of a large number of sheets or other non-sheeted objects, for example, notebooks.

It should, therefore, be appreciated that there is a need for pockets that are made of inexpensive materials, and that are configured to securely retain many sheets of paper without deforming the pocket. The present invention satisfies these needs.

### SUMMARY

The present invention relates to providing a novel expandable pocket for use with loose leaf binders or other sheet-retaining devices. The pocket incorporates an elastomeric material to provide resiliency. The elastomeric material is easily incorporated into existing manufacturing processes for making binders and other sheet-retaining devices.

One exemplary embodiment of the invention is an apparatus including a pocket that is at least partially defined by an elastomeric film. The elastomeric film includes a material having a styrene block copolymer, a polyolefin, a polyurethane, a polystyrene, an ethylene vinyl acetate copolymer, a processing oil, or mixtures thereof.

In other, more detailed features of the invention, the material is a styrene block copolymer, and the styrene block copolymer is styrene-butadiene-styrene, styrene-isoprene-styrene, styrene-ethylene-butylene-styrene, styrene-ethylene-propylene-styrene, or mixtures thereof.

In other, more detailed features of the invention, the material is a polyolefin, and the polyolefin is a polyolefin rubber. Also, the material can be a polyolefin, and the polyolefin can be an elastic polyolefin or a non-elastic polyolefin.

In other, more detailed features of the invention, the material is a mixture of a styrene block copolymer and a polyolefin, the styrene block copolymer is a mixture of styrene-butadiene-styrene and styrene-isoprene-styrene, and the polyolefin is an elastic polyolefin.

In other, more detailed features of the invention, the elastomeric film has a multilayer configuration and at least one layer of the multilayer configuration can include an additive that is an antiblocking agent and/or a slip promoter. In addition, if the additive is an antiblocking agent, the antiblocking agent can be a solid filler and/or a compound of silica particles. Furthermore, if the additive is a slip promoter, the slip promoter can be a fluoropolymer. Also, the additive has an additive weight, the at least one layer has a total weight, and the additive weight ranges in value from five percent to ninety percent of the total weight.

In other, more detailed features of the invention, the apparatus is a binder, a folder, a report cover, a divider, or a sheet protector. Also, the apparatus can further include a non-elastic component, and the elastomeric film is welded to the non-elastic component.

Another exemplary embodiment is a binder including a cover having a pocket. The pocket is at least partially defined by an elastomeric film. The elastomeric film includes a material having a styrene block copolymer, a polyolefin, a polyurethane, a polystyrene, an ethylene vinyl acetate copolymer, a processing oil, or mixtures thereof. The binder can further include a cover, and the elastomeric film is welded to the cover.

An exemplary method according to the invention is a method for manufacturing an apparatus. The method includes providing an elastomeric film that includes a material having a styrene block copolymer, a polyolefin, a polyurethane, a polystyrene, an ethylene vinyl acetate copolymer, a processing oil, or mixtures thereof, providing a nonelastic component; and coupling the elastomeric film to the non-elastic component to form a pocket.

In other, more detailed features of the invention, the apparatus is a binder having a cover, and the non-elastic component is the cover of the binder. Also, the non-elastic component can include a non-woven material.

In other, more detailed features of the invention, the method further includes activating the elastomeric film to provide a unidirectional stretch property to the elastomeric film before the step of coupling the elastomeric film to the non-elastic component. Also, the step of coupling the elastomeric film to the non-elastic component can include laminating the elastomeric film to the non-elastic component. In addition, the step of coupling the elastomeric film to the non-elastic component includes welding. The welding step can be accomplished using ultrasonic welding, radio-frequency welding, and/or thermal welding. Furthermore, the elastomeric film can be releasably coupled to the non-elastic component using a removable adhesive, VELCRO, and/or a snap.

Other features of the invention should become apparent to individuals who are skilled in the art from the following description of the preferred embodiments taken in conjunction with the accompanying drawings, which illustrate, by way of example, the principles of the invention, the invention not being limited to any particular preferred embodiment(s) disclosed.

### BRIEF DESCRIPTION OF THE DRAWINGS

These and other features, aspects, and advantages of the present invention will become better understood with reference to the following description, appended claims, and accompanying drawings, where:

FIG. 1 is a perspective view of an example binder having front and back covers, with each cover including a pocket according to the invention.

FIG. 2 is a sectional view of an example elastomeric film having a multilayer configuration according to the invention.

FIG. 3 is a flowchart of an example method for manufacturing an apparatus that includes a pocket according to the invention.

Unless otherwise indicated, the illustrations in the above figures are not necessarily drawn to scale.

### DETAILED DESCRIPTION

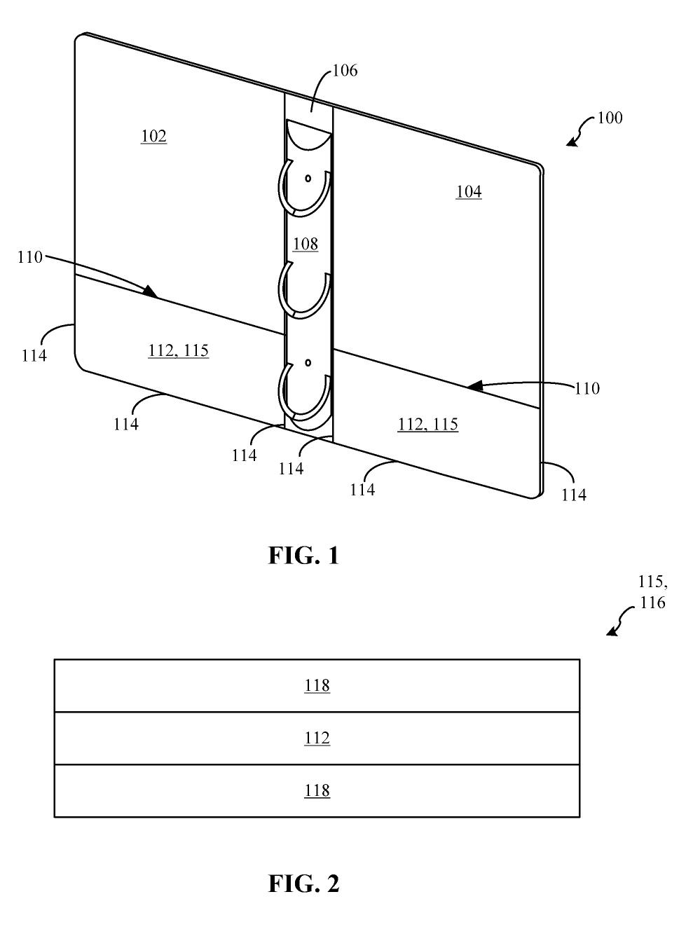

The invention relates to use of a novel elastomeric film to make expandable pockets, e.g., binder pockets, for use in retaining devices, e.g., sheet-retaining devices. A sheet-retaining device, for example, a binder 100 is illustrated in FIG. 1. The binder 100 (e.g., a ring binder) can include front and back covers 102 and 104, respectively, and a spine 106. A binding mechanism can be disposed on or near the spine. For example, in the embodiment shown, the binding mechanism 108 is attached to the spine. Either one or both covers 102 and 104 can include a pocket 110 constructed using the novel elastomeric film 112 described in the present invention.

The pocket 110 can be formed from a continuous sheet of the elastomeric film 112 connected to the front and back covers 102 and 104, respectively, and the spine 106 along portions of the edges 114 of the covers and spine. Thus, the elastomeric film at least partially defines the pocket. The film can be attached either continuously or discontinuously to the cover and/or spine according to known techniques in the art, for example, by welding (e.g., ultrasonic, radio-frequency, or thermal welding techniques). Alternatively, one or more portions of the elastomeric film can be coupled to the cover and/or spine by a releasable method/technique (e.g., using removable adhesive, VELCRO, or a snap button). The attachment can be by welding using known equipment to individuals who are skilled in the art.

Presently, the polymeric film covering material used in sheet-retaining devices is predominantly made from either polyvinyl chloride (“PVC”) or polyolefins, e.g., polypropylene (“PP”). Inside pockets of such sheet-retaining devices are also made from the same materials. These materials are not elastic, and thus, undergo permanent deformation upon stretching (also referred to as “permanent set”) and do not have high enough retractive force to hold stored items tight.

A common way of attaching the polymeric film that forms the pocket in a binder is by use of heat and/or ultrasonic welding. In both cases, the materials of both the binder cover and the pocket are essentially bonded by heat.

Unlike the above-mentioned materials, pockets 110 that are made out of the elastomeric films 112 of the present invention possess a high degree of elasticity, low permanent set, and strong retractive force. In fact, the percentage elongation with no permanent set (i.e., where the final length after stretching minus the initial length before stretching equals zero) for some embodiments can range from 100 percent to 150 percent. In other embodiments, the percentage elongation with no permanent set can range from 100 percent to 135 percent. In yet another embodiment, the percentage elongation with no permanent set can range from 100 percent to 150 percent along direction within the film, and the percentage elongation with no permanent set along another direction within the film can range from 100 percent to 135 percent. Also, in some embodiments, the tensile strength can range from 2900 psi to 4200 psi (ASTM D-882-95a). Embodiments of the film have a thickness from approximately 2 mils to approximately 15 mils.

It is essential to realize that the choice of the material for the pocket 110 can play a significant role in both the physical performance of the pocket and the manufacturability of the film 112 to form the pocket including its bonding to the binder cover material.

Elastomers that can be used to make such a film 112 for a pocket 110 include styrene block copolymers (e.g., styrene-butadiene-styrene (“SBS”), styrene-isoprene-styrene (“SIS”), styrene-ethylene-butylene-styrene (“SEBS”), styrene-ethylene-propylene-styrene (“SEPS”), etc.), polyolefin rubber, polyurethanes, and/or mixtures thereof. Examples of styrene block copolymers are elastomers made by the following: Kraton of Houston, Tex. (under the brand name KRATON), Dexco Polymers LP of Houston, Tex. (under the brand name VECTOR), Kuraray of Houston, Tex. (under the brand name SEPTON), and others. The polyolefin rubber example is the family of VISTAMAXX resins by ExxonMobil Corporation of Houston, Tex. Sometimes, it is advantageous to add other resins, e.g., PP or polystyrene (“PS”), to improve physical and mechanical properties of the film.

Embodiments of the film 112 include a single thermoplastic elastomer or a mixture of elastomers with other miscible polymers. In other embodiments, the film includes a composite material including microfibers that are dispersed in a matrix of an elastomeric blend. An example embodiment of a film composition is the following:

KRATON G2832-50%, VISTAMAXX VM1100-45%, PP DS6D81-5%.

In one embodiment, the elastomeric film 112 comprises SEBS and/or SEPS block copolymers. These resins provide excellent bonding to PP, and good thermal stability during processing as well as excellent mechanical properties. SEBS and SEPS block copolymers are fully saturated, non-styrenic blocks, and are less susceptible to degradation as a result of heat and oxidation than SIS and SBS.

In another embodiment, the elastomeric film 112 further comprises a mixture of SEBS and/or SEPS with a polyolefin that can be either elastic or non-elastic. This film possesses excellent thermal stability and welding characteristics with balanced mechanical properties.

In another embodiment, the elastomeric film 112 comprises elastic polyolefin with or without non-elastic polyolefin. This film has excellent thermal stability, manufacturability, and affinity to the binder material.

In another embodiment, the elastomeric film 112 comprises a mixture of elastic polyolefin with SBS and/or SIS block copolymers. The addition of the block copolymers improves mechanical properties of the film.

In one embodiment, in addition to the materials described in the previous embodiments, the elastomeric film 112 can include polystyrene, ethylene vinyl acetate copolymer, and/or processing oil. An example processing oil is PARALUX 6001R, which is a paraffin from Chevron-Texaco of San Ramon, Calif., as discussed in International Patent Application Publication Number WO 2006/004637 to Fouse et al. (“the Fouse Patent Application”), which is incorporated by reference herein in its entirety.

In another embodiment, the elastomeric film 112 can be laminated to a nonelastic material, for example, a nonwoven material and subsequently activated through post-processing treatment to provide a unidirectional stretching property. One such laminate construction is described in the Fouse Patent Application. The unidirectional stretching property is particularly useful in the manufacturing of the sheet-retaining device 100. Examples of laminates that include a non-woven material and a high-stretch elastic film are FABRIFLEX Elastic Laminates or FLEXAIRE Elastic Laminates by Tredegar Corporation of Richmond, Va.

Embodiments of the elastomeric film 112 can be made by extruding a mixture of the above-mentioned resins onto a cast roll, by blown film extrusion, or any other methods known to individuals who are skilled in the art.

The elastomeric film 112 can be relatively sticky, can tend to block itself in a roll during storage, and can be difficult to handle during processing. Referring additionally to FIG. 2, to facilitate converting of another embodiment of the elastomeric film 115 the elastomeric film is made in a multilayer configuration 116 to prevent blocking. The multilayer configuration includes skins 118, i.e., individual layers of another film, which can be made of a relatively inelastic material, e.g., PP, PE, PS, etc., that do not block. The multilayer film configuration can include one or two skins. As illustrated in FIG. 2, the skin(s) is(are) coupled to a surface of the elastomeric film. The thin skins do not contribute much to the bulk properties of the film. Examples of skins (also referred to as skin layers) are found in U.S. Pat. Nos. 4,713,273, 5,186,782, and 5,516,393 to Freedman, all of which are incorporated by reference herein in their entireties.

The skins 118 can also be made out of elastomeric materials described above by incorporating antiblocking agents and slip promoters as additives. Examples of antiblocking agents are compounds of silica particles and other solid fillers (e.g., calcium carbonate, talc, etc.) in the carrier of choice (e.g., PP, PS, etc.) produced, for example, by A Schulman Inc. of Akron, Ohio. This carrier can also be elastic, e.g., a styrene-butadiene copolymer (“SBC”) from BASF of Freeport, Tex. (under brand name STYROLUX). Typically, slip promoters are fluoropolymers, e.g., DYNEON, DYNAMAR from 3M of St. Paul, Minn.), VITON (DuPont, i.e., E.I. du Pont de Nemours and Company, of Wilmington, Del.), etc. The additives content of the antiblocking agent(s) and/or the slip promoter(s) can vary from 5% to 90% of the total weight of the skin composition.

In embodiments, the elastomeric film 112 and 115 is perforated or apertural. Also, embodiments of the elastomeric film are embossed for reduced contact surface area, which allows for the easy insertion of items into the pocket 110, and/or removal of items from the pocket. In addition, embodiments of the elastomeric film can include alternating strips or regions within the film that have different values of elasticity, e.g., a region having a high value of elasticity adjacent to a region having a low value of elasticity. In particular, in one embodiment, a less elastic material is placed at the top, e.g., the top one inch of a two-inch deep pocket, of the elastomeric film, to maintain sufficient compressive strength at the top of the pocket so items are secured within the pocket.

An embodiment of an example binder 100 can be made using the following steps: provide stock for the binder covers 102 and 104 and the spine 106, provide a polymeric film covering for the binder, provide an elastomeric film 112 and 115 for the binder pocket 110, assemble the binder with the pocket, and seal the polymeric film covering and elastomeric material for the binder pocket to complete the binder

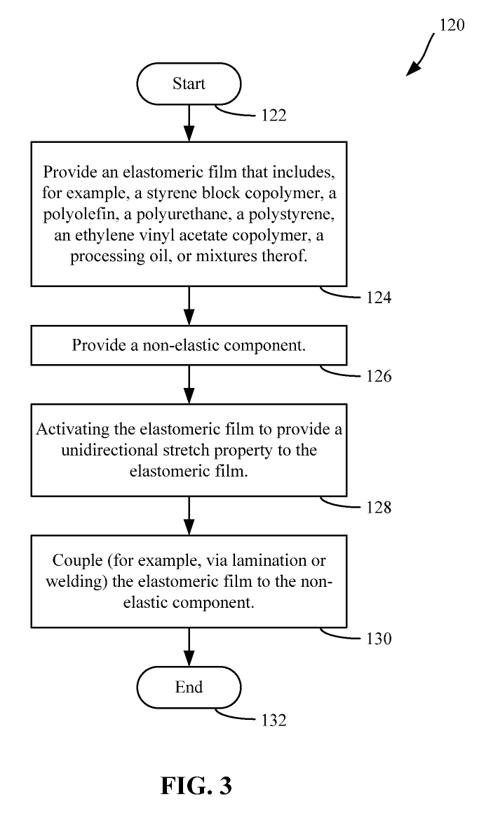

An exemplary method for manufacturing an apparatus 100 that includes a pocket 110 is illustrated in the flowchart 120 of FIG. 3. After starting the method at step 122, the next step 124 is to provide an elastomeric film 112 and 115 that includes, for example, a styrene block copolymer, a polyolefin, a polyurethane, a polystyrene, an ethylene vinyl acetate copolymer, a processing oil, or mixtures thereof. Next, at step 126, a non-elastic component is provided. At step 128 (an optional step), the elastomeric film is activated to provide a unidirectional stretch property to the elastomeric film. Next, at step 130, the elastomeric film is coupled to the non-elastic component, for example, via lamination or welding. The method ends at step 132.

Binders 100 made using the above-described invention advantageously provide the following: larger capacity pockets 110 to hold loose sheets, bound documents, or other objects; pockets that can return to their original state (i.e., original shape and/or form) after the contents have been removed from the pockets without appearing unsightly; pockets that can securely hold the contents, thus preventing any inadvertent dislodging of the contents from the pockets; and film materials 112 and 115 that can be easily incorporated within existing manufacturing processes without substantial added costs to the end user.

All features disclosed in the specification, including the claims, abstract, and drawings, and all steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments may provide different capabilities and benefits, depending on the configuration used to implement the key features of the invention. Accordingly, the scope of the invention is defined only by the following claims.

We claim:

1. An apparatus comprising:
a. a pocket that is at least partially defined by an elastomeric film;
b. wherein the elastomeric film includes a material selected from the group consisting of a styrene block copolymer, a polyolefin, a polyurethane, a polystyrene, an ethylene vinyl acetate copolymer, a processing oil, and mixtures thereof.

2. The apparatus according to claim 1, wherein:
a. the material is a styrene block copolymer; and
b. the styrene block copolymer is selected from the group consisting of styrene-butadiene-styrene, styrene-isoprene-styrene, styrene-ethylene-butylene-styrene, styrene-ethylene-propylene-styrene, and mixtures thereof.

3. The apparatus according to claim 1, wherein:
a. the material is a polyolefin; and
b. the polyolefin is a polyolefin rubber.

4. The apparatus according to claim 1, wherein:
a. the material is a polyolefin; and
b. the polyolefin is selected from the group consisting of an elastic polyolefin and a non-elastic polyolefin.

5. The apparatus according to claim 1, wherein:
a. the material is a mixture of a styrene block copolymer and a polyolefin;
b. the styrene block copolymer is a mixture of styrene-butadiene-styrene and styrene-isoprene-styrene; and
c. the polyolefin is an elastic polyolefin.

6. The apparatus according to claim 1, wherein:
a. the elastomeric film includes a multilayer configuration having at least one layer; and
b. the at least one layer of the multilayer configuration includes an additive selected from the group consisting of an antiblocking agent and a slip promoter.

7. The apparatus according to claim 6, wherein:
a. the additive is an antiblocking agent; and
b. the antiblocking agent is selected from the group consisting of a solid filler and a compound of silica particles.

8. The apparatus according to claim 6, wherein:
a. the additive is a slip promoter; and
b. the slip promoter is a fluoropolymer.

9. The apparatus according to claim 6, wherein:
a. the additive has an additive weight;
b. the at least one layer has a total weight; and
c. the additive weight ranges in value from five percent to ninety percent of the total weight.

10. The apparatus according to claim 1, wherein the apparatus is selected from the group consisting of a binder, a folder, a report cover, a divider, and a sheet protector.

11. The apparatus according to claim 1, further comprising a non-elastic component, wherein the elastomeric film is welded to the non-elastic component.

12. A binder comprising:
a. a cover including a pocket;
b. wherein:
i. the pocket is at least partially defined by an elastomeric film, and
ii. the elastomeric film includes a material selected from the group consisting of a styrene block copolymer, a polyolefin, a polyurethane, a polystyrene, an ethylene vinyl acetate copolymer, a processing oil, and mixtures thereof.

13. The binder according to claim 12, wherein
a. the elastomeric film includes a multilayer configuration having at least one layer; and
b. the at least one layer of the multilayer configuration includes an additive selected from the group consisting of an antiblocking agent and a slip promoter.

14. The binder according to claim 12, further comprising a cover, wherein the elastomeric film is welded to the cover.

15. A method for manufacturing an apparatus, the method includes:
a. providing an elastomeric film that includes a material selected from the group consisting of a styrene block copolymer, a polyolefin, a polyurethane, a polystyrene, an ethylene vinyl acetate copolymer, a processing oil, and mixtures thereof,
b. providing a nonelastic component; and
c. coupling the elastomeric film to the non-elastic component to form a pocket.

16. The method according to claim 15, wherein:
a. the apparatus is a binder having a cover; and
b. the non-elastic component is the cover of the binder.

17. The method according to claim 15, wherein the non-elastic component includes a non-woven material.

18. The method according to claim 15, further comprising activating the elastomeric film to provide a unidirectional stretch property to the elastomeric film before the step of coupling the elastomeric film to the non-elastic component.

19. The method according to claim 15, wherein the step of coupling the elastomeric film to the non-elastic component includes laminating the elastomeric film to the non-elastic component.

20. The method according to claim 15, wherein the step of coupling the elastomeric film to the non-elastic component includes welding.

21. The method according to claim 20, wherein the elastomeric film is welded to the non-elastic component using a technique selected from the group consisting of ultrasonic welding, radio-frequency welding, and thermal welding.

22. The method according to claim 15, wherein the step of coupling the elastomeric film to the non-elastic component is accomplished using a releasable technique selected from the group consisting of a removable adhesive, VELCRO, and a snap.
